(19) United States
(12) Patent Application Publication
(10) Pub. No.: US 2023/0213456 A1
(43) Pub. Date: Jul. 6, 2023

(54) LEATHER DEFECT DETECTION SYSTEM

(71) Applicant: FENG CHIA UNIVERSITY, Taichung City (TW)

(72) Inventors: Sze Teng LIONG, Taichung City (TW); Yee Siang GAN, Taichung City (TW); Wen Hong LIN, Taichung City (TW); Che Ming LI, Taichung City (TW)

(21) Appl. No.: 18/069,706

(22) Filed: Dec. 21, 2022

(30) Foreign Application Priority Data
Jan. 3, 2022 (TW) 111100113

(51) Int. Cl. G01N 21/88; G06T 7/00

(52) U.S. Cl. CPC G01N 21/8851; G06T 7/0004; G01N 2021/888; G01N 2021/8874; G06T 2207/20081

(57) ABSTRACT

A leather defect detection system comprises a worktable, a conveying mechanism, an image capture module, a model training computing device and an embedded computing device, the worktable is used to place a to-be-detected leather; the conveying mechanism is movably disposed on the worktable; the image capture module is disposed on the conveying mechanism, when the conveying mechanism is actuated, relative positions of the image capture module and the to-be-detected leather change synchronously to capture a plurality of to-be-detected images respectively; the model training computing device uses a plurality of historical leather images captured by the image capture module to perform calculation to establish a defect identification model, and the defect identification model is transcoded into the embedded computing device, so that the embedded computing device is capable of directly using the transcoded defect identification model to perform defect identification on the to-be-detected images.

### BACKGROUND OF THE INVENTION

### Field of the Invention

The invention is related to detection technology, and more particularly to a leather defect detection system.

### Related Art

Generally, because natural leather is obtained from animal body parts and due to differences between different individuals, it will inevitably have traces of skin lines, wrinkles, scars and scabs, dyeing, black pigment spots, insect bites, blood vessels and pores, so traditional tanneries will inspect and grade the leather according to the quality of the leather, and sell it according to the grade.

During the inspection process, the staff needs to inspect each piece of leather for defects one by one; however, it is still difficult to avoid visual fatigue, parallax illusions, and differences in the judgment standards of different staff when observing with the human eye, so there are problems such as human error and operating efficiency.

### SUMMARY OF THE INVENTION

Therefore, a main object of the invention is to provide a leather defect detection system, which applies automatic i Related Artmage identification technology to detection of leather defects, and is capable of scanning an entire leather without manual operation to reduce human errors, and at the same time, through automatic operation, to improve an efficiency of inspection operation in order to achieve an efficacy of reducing time cost.

Another object of the invention is to provide a leather defect detection system, which adopts deep learning to train a large amount of image data, constructs a defect identification model accordingly, and transfers the defect identification model to an embedded computing device to independently perform defect identification operation, thereby the problem of data to be detected must be sent to a remote host for identification before an identification result can be returned in the traditional technology can be improved, so the leather defect detection system is capable of reducing the time spent on traditional calculation and avoiding data loss due to unsuccessful transmission.

In order to achieve the above-mentioned objects, the leather defect detection system provided by the invention comprises a worktable, a conveying mechanism, an image capture module, a model training computing device and an embedded computing device, wherein the worktable is used to place a to-be-detected leather; the conveying mechanism is movably disposed on the worktable; the image capture module is disposed on the conveying mechanism, when the conveying mechanism is actuated, relative positions of the image capture module and the to-be-detected leather change synchronously to capture a plurality of to-be-detected images respectively; the model training computing device uses a plurality of historical leather images captured by the image capture module to perform calculation to establish a defect identification model, and the defect identification model is transcoded into the embedded computing device, so that the embedded computing device is capable of directly using the transcoded defect identification model to perform defect identification on the to-be-detected images.

Specifically, the model training computing device has a first database, a pre-processing module, a model training module and a transcoding module, wherein the first database stores the historical leather images captured by the image capture module; the pre-processing module performs grayscale processing and binarization on each of the historical leather images respectively to obtain a pre-processed image in black and white, black pixels in each of the pre-processed images represent parts with defects, while white pixels represent flawless parts; the model training module receives the pre-processed images and extracts the parts containing black pixels in each of the pre-processed images for calculation to establish a defect identification model; and the transcoding module transcodes the defect identification model.

In one embodiment, the model training computing device further comprises a data augmentation module to perform data augmentation (DA) image processing on the historical leather images to obtain a plurality of augmented images to be used as another training sample for the defect identification model after being processed by the pre-processing module.

The embedded computing device has a second database, a processing module and an evaluation module, wherein the second database receives and stores the defect identification model transcoded by the transcoding module; the processing module inputs the to-be-detected images into the transcoded defect identification model to perform calculation to identify whether the to-be-detected leather has defects, and outputs a synthetic image covering an entire size of the to-be-detected leather; wherein when there is a defect in the to-be-detected leather, a defect mark is marked on the synthetic image, and the defect mark comprises a defect type, defect coordinates and a defect size; the evaluation module calculates a proportion of the defect on the to-be-detected leather based on the defect size, and uses any one or a combination of the defect type, the defect coordinates and a historical information of the to-be-detected leather in order to calculate an estimated price of leather.

In one embodiment, the embedded computing device is an artificial intelligence computing device of a Jetson nano kit.

In one embodiment, the model training module further adjusts or retrains the defect identification model based on a calculation result of a defect judgment formula, and the defect judgment formula comprises the following relational expressions:

accuracy=(TP+TN)/(TP+FP+FN+TN);

recall=TP/(TP+FN); and

precision=TP/(TP+FP).

Wherein TP represents an actual defect, and the defect identification model accurately judges as a defect;

TN represents an actual non-defect, and the defect identification model accurately judges as a non-defect;

FP represents an actual defect, and the defect identification model misjudges as a non-defect; and

FN represents an actual non-defect, and the defect identification model misjudges as a defect.

In one embodiment, the conveying mechanism comprises a frame, a slide rail, a moving seat and a driving unit, wherein the frame is disposed on the worktable; the slide rail is disposed apart from the worktable on the frame; the moving seat is movably disposed on the slide rail and is used to carry the image capture module; the driving unit is connected with the moving seat to drive the moving seat to move relative to the slide rail so that the image capture module is capable of capturing the whole to-be-detected leather during a moving process.

In one embodiment, the driving unit has a control module, a motor and a transmission component, the control module is an artificial intelligence calculation device of an Arduino Nano kit for controlling operation and stop of the motor, and the transmission component converts and transmits rotational motions of the motor to the moving seat, so that the moving seat is capable of reciprocating in a direction in which the slide rail extends.

In one embodiment, the historical information comprises leather types, origins, leather-cutting parts and leather sizes. Wherein the leather-cutting parts include shoulders, abdomen, square leather and buttocks.

In one embodiment, the defect type is classified into dot, fine dot, line, strip, irregularity, pattern or hole according to shape and form.

### BRIEF DESCRIPTION OF DRAWINGS

FIG. 1 is a perspective view of a leather defect detection system according to a preferred embodiment of the invention.

FIG. 2 is a system block diagram of the leather defect detection system according to a preferred embodiment of the invention.

### DETAILED DESCRIPTION OF THE INVENTION

First of all, the nouns mentioned in this specification are explained as follows.

The term “calculation” or “algorithm” in this invention refers to a program that is capable of comparing and calculating input data, and the program refers to using various applicable statistical analysis and artificial intelligence algorithms and devices, such as regression analysis method, hierarchical analysis method, cluster analysis method, neural network algorithm, genetic algorithm, machine learning algorithm, deep learning algorithm.

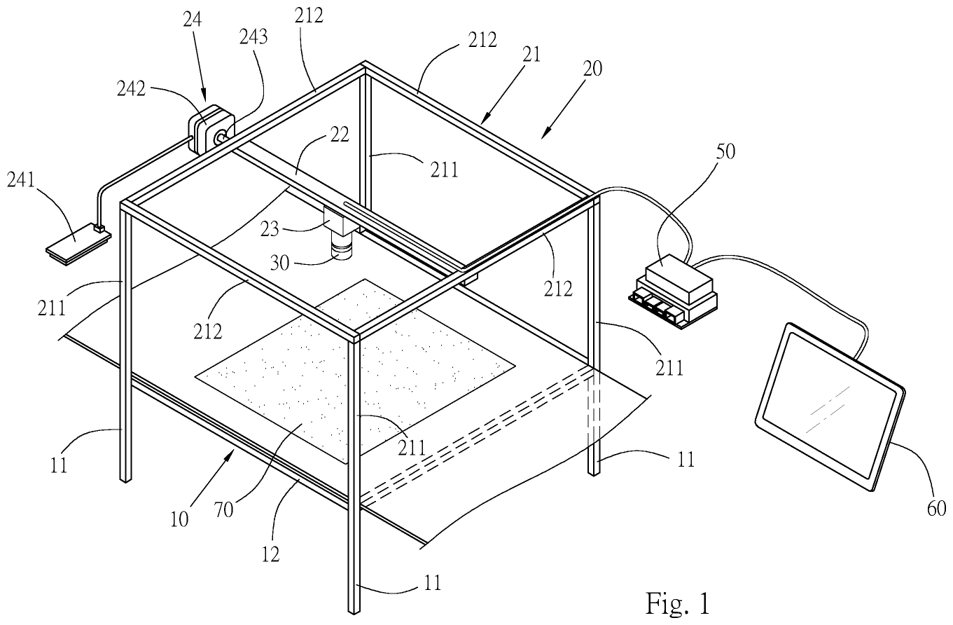

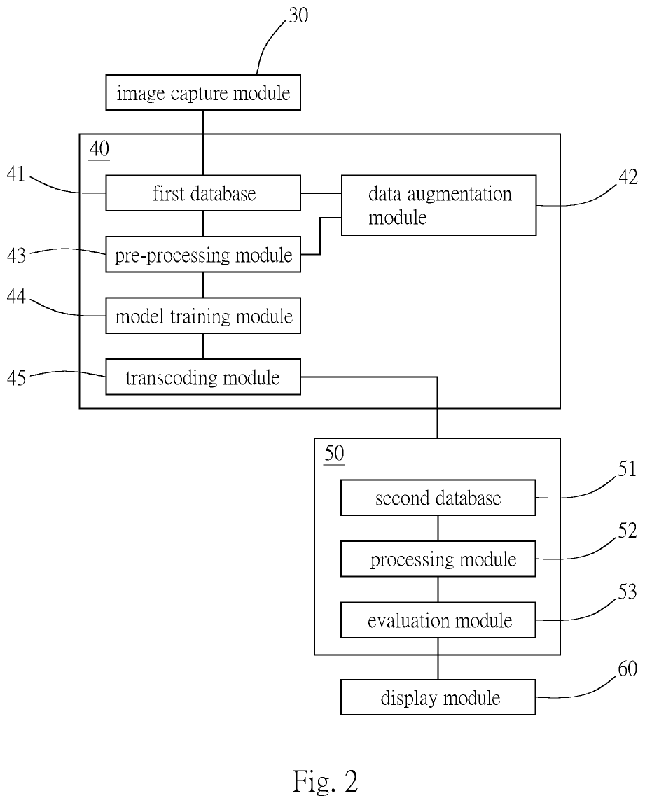

Furthermore, please refer to FIG. 1 and FIG. 2 for a leather defect detection system according to a preferred embodiment of the invention, which mainly comprises a worktable 10, a conveying mechanism 20, an image capture module 30, a model training computing device 40, an embedded computing device 50 and a display module 60, wherein the image capture module 30, the model training computing device 40, the embedded computing device 50 and the display module 60 are connected by wireless communication modes such as 4G, 5G, WIFI, Bluetooth, NFC or RFID, or by wired transmission.

The worktable 10 is used as a basic structure for carrying other components. In this embodiment, the worktable 10 is mainly composed of four supports 11 and a board 12. The board 12 is used to place a to-be-detected leather 70 flatly, and a size of the board 12 can be set according to a maximum size of the to-be-detected leather 70.

The conveying mechanism 20 comprises a frame 21, a slide rail 22, a moving seat 23 and a driving unit 24, wherein the frame 21 has four uprights 211 and four cross bars 212, the cross bars 212 are connected with one another to form a frame-like structure, one end of each of the uprights 211 is connected to each of four corners of the structure respectively, and another end of each of the uprights 211 is connected to each of the supports 11, so that the frame 21 is assembled on the worktable 10. In this embodiment, each of the uprights 211 and the corresponding support 11 are integrally formed, and in other embodiments, each of the uprights 211 and each of the supports 11 can also be an independent component, and a detachable combination relationship is between each of the uprights 211 and each of the supports 11.

Two ends of the slide rail 22 are respectively connected to any of the two cross bars 212 parallel to each other, and straddle above the board 12, and a predetermined distance is between the slide rail 22 and the worktable 10.

The moving seat 23 is movably disposed on the slide rail 22, and the moving seat 23 is driven by the driving unit 24 to move relative to the slide rail 22. In other embodiments, a plurality of rolling elements can be provided between the slide rail 22 and the moving seat 23 to reduce frictional force and reduce energy loss.

The driving unit 24 has a control module 241, a motor 242 and a transmission component 243, the control module 241 is an artificial intelligence calculation device of an Arduino Nano kit, which is used to control operation and stop of the motor 242, and the transmission component 243 converts and transmits rotational motions of the motor 242 to the moving seat 23, so that the moving seat 23 is capable of reciprocating in a direction in which the slide rail 22 extends.

The image capture module 30 can be but is not limited to a video camera, a camera, a device including charge-coupled device (CCD) or complementary metal-oxide-semiconductor (CMOS), and the image capture module 30 is disposed on the moving seat 23 of the conveying mechanism 20, when the conveying mechanism 20 is actuated, relative positions of the image capture module 30 and the to-be-detected leather 70 are changed synchronously, so that the image capture module 30 is capable of capturing the whole to-be-detected leather 70 during a moving process in order to obtain a plurality of to-be-detected images. Accordingly, using fully automated operation instead of manual photography can not only save manual work time, but also avoid errors caused by human operation faults.

The model training computing device 40 has a first database 41, a data augmentation module 42, a pre-processing module 43, a model training module 44 and a transcoding module 45, wherein the first database 41 and the modules are electrically connected to one another.

The first database 41 can be but is not limited to a phase-change memory (PRAM), a static random access memory (SRAM), a dynamic random access memory (DRAM), a flash memory disk, a read-only memory (ROM), a random access memory (RAM), and is capable of storing a plurality of historical leather images captured by the image capture module 30.

The pre-processing module 43 excludes errors or inapplicable ones in the historical leather images first to reduce inaccuracy, but the exclusion method is a conventional technology, so it is not repeated herein. Then, the pre-processing module 43 unifies size and specification of the historical leather images, if an image with a small size or data volume is used, it is conducive to speed of calculation training, but it should be noted that dilution may occur if an amount of information is too small. Afterwards, the pre-processing module 43 performs grayscale processing and binarization on each of the historical leather images respectively to obtain a pre-processed image in black and white, black pixels in each of the pre-processed images represent parts with defects, while white pixels represent flawless parts. Accordingly, in addition to increasing a speed of calculation training, parts with black defects are emphasized and highlighted.

The model training module 44 receives the pre-processed images, and extracts parts containing black pixels in each of the pre-processed images for calculation in order to establish a defect identification model.

Furthermore, in order to train a good and high-quality model, there must be sufficient amount of data, so the data augmentation module 42 performs data augmentation (DA) image processing on the historical leather images, and each of the historical leather images is shifted upward, downward, leftward, and rightward, or vertically flipped, horizontally flipped to obtain a plurality of similar augmented images. Then, after the augmented images are processed by the pre-processing module 43, the augmented images can be used as another training sample for the defect identification model.

The transcoding module 45 transcodes the defect identification model, which can be implemented by using any suitable high-level, low-level, object-oriented, visual, compiled and/or interpreted programming language, such as C, C++, Java, BASIC, Matlab, Pascal, Visual BASIC, assembly language, machine code, or the like. In this embodiment, the GPUcoder (transcoder) in Matlab is used for transcoding.

The embedded computing device 50 is an artificial intelligence computing device of a Jetson Nano kit, and the Jetson Nano itself is lighter in size than a computer, which can effectively reduce a size of the overall system and can also meet the demands of factories. In this embodiment, the embedded computing device 50 has a second database 51, a processing module 52 and an evaluation module 53, and the modules are electrically connected to one another for transmitting data.

The second database 51 receives and stores the defect identification model transcoded by the transcoding module 45.

The processing module 52 directly inputs the to-be-detected images into the transcoded defect identification model to perform calculation in order to identify whether the to-be-detected leather 70 has defects, and outputs a synthetic image covering an entire size of the to-be-detected leather 70. Accordingly, the problem of data to be detected must be sent to a remote host for identification before an identification result can be returned in the traditional technology can be improved by the invention, so the leather defect detection system is capable of reducing the time spent on traditional calculation and avoiding data loss.

When there is a defect in the to-be-detected leather 70, the processing module 52 marks a defect mark on the synthetic image, and the defect mark comprises a defect type, defect coordinates and a defect size, thereby achieving an object of intelligently identifying leather defects.

Wherein the defect type is classified into dot, fine dot, line, strip, irregularity, pattern or hole according to shape and form. In this embodiment, in order to realize accurate and rapid detection of leather defects, the processing module 52 only identifies two types of defects that often appear on leather, such as line and hole.

In addition, in order to verify whether the defect identification model meets a predetermined standard, the model training module 44 receives a defect identification result fed back by the processing module 52, and performs a verification procedure with a defect judgment formula, and the defect judgment formula comprises the following relational expressions:

accuracy=(TP+TN)/(TP+FP+FN+TN);

recall=TP/(TP+FN); and

precision=TP/(TP+FP).

Wherein TP represents an actual defect, and the defect identification model accurately judges as a defect;

TN represents an actual non-defect, and the defect identification model accurately judges as a non-defect;

FP represents an actual defect, and the defect identification model misjudges as a non-defect; and

FN represents an actual non-defect, and the defect identification model misjudges as a defect.

For example, when a verification result meets a predetermined standard, it represents that the accuracy is not less than a predetermined threshold, and training procedure can be ended; when a verification result does not meet a predetermined standard, it represents that the accuracy is less than a predetermined threshold, training procedure needs to be repeated, and by adjusting parameters or improving data, such as parameter tuning or manifold learning, until the accuracy is not less than a predetermined threshold. In this embodiment, the predetermined threshold is 95%. Accordingly, the invention is capable of replacing manpower, intelligently identifying leather defects, and avoiding the problems of environmental protection and waste of resources caused by excessive waste leather in a process of cutting and trimming due to human errors in judgment.

In particular, the invention can further specify a same type of leather (such as cowhide) for calculation, training and identification, which can avoid the complexity of information, increase the time of calculation, and enable an identification speed of the embedded computing device 50 to be within an acceptable range.

The evaluation module 53 calculates a proportion of a defect on the to-be-detected leather 70 based on the defect size, and uses any one or a combination of the defect type, the defect coordinates and a historical information of the to-be-detected leather 70 to calculate an estimated price of leather. Wherein the evaluation module 53 can be supplemented with methods such as arithmetic mean method, weighted arithmetic mean method, simple sequential average method, weighted sequential average method, exponential smoothing forecasting method, seasonal trend forecasting method or market life cycle forecasting method to estimate a price of leather.

The historical information comprises leather types, origins, leather-cutting parts and leather sizes, and the leather-cutting parts include shoulders, abdomen, square leather and buttocks.

The display module 60 can be, but is not limited to, a liquid crystal display (LCD), an organic light-emitting diode display (OLED), or other display devices that can be identified by human senses, so that the display module 60 can be controlled by the model training computing device 40 or the embedded computing device 50, and is capable of optionally displaying the synthetic image, the estimated price of leather, the to-be-detected images, the historical leather images, or a real-time image of the image capture module 30 for viewing or checking by a user.

In addition, the invention can cooperate with an inventory management system to manage an inventory quantity of leather regularly or irregularly, wherein when the inventory quantity is lower than a predetermined value, the user is notified of the need to purchase, and a required replenishment quantity of purchase is suggested; when the inventory quantity exceeds the predetermined value, the user is notified not to purchase. Accordingly, situations such as insufficient replenishment and out of stock can be avoided, and an efficacy of early warning can be achieved.

The above is only a detailed description of the invention through each of the embodiments, without departing from the spirit of the invention, any simple modifications or changes made to the embodiments in the specification by a person having ordinary skill in the art should deemed to be within the scope of the claims.

What is claimed is:

1. A leather defect detection system comprising:
a worktable used for placing a to-be-detected leather;
a conveying mechanism movably disposed on the worktable;
an image capture module disposed on the conveying mechanism, when the conveying mechanism being actuated, relative positions of the image capture module and the to-be-detected leather changing synchronously to capture a plurality of to-be-detected images respectively;
a model training computing device electrically connected with the image capture module, the model training computing device having a first database, a pre-processing module, a model training module and a transcoding module, wherein:
the first database stores the historical leather images captured by the image capture module;
the pre-processing module performs grayscale processing and binarization on each of the historical leather images respectively to obtain a pre-processed image in black and white, wherein black pixels in each of the pre-processed images represent parts with defects, while white pixels represent flawless parts;
the model training module receives the pre-processed images and extracts the parts containing black pixels in each of the pre-processed images for calculation to establish a defect identification model; and
the transcoding module transcodes the defect identification model; and
an embedded computing device electrically connected with the model training computing device, the embedded computing device having a second database, a processing module and an evaluation module, wherein:
the second database receives and stores the defect identification model transcoded by the transcoding module;
the processing module inputs the to-be-detected images into the transcoded defect identification model to perform calculation in order to identify whether the to-be-detected leather has defects, and outputs a synthetic image covering an entire size of the to-be-detected leather; wherein when there is a defect in the to-be-detected leather, a defect mark is marked on the synthetic image, and the defect mark comprises a defect type, defect coordinates and a defect size; and
the evaluation module calculates a proportion of the defect on the to-be-detected leather based on the defect size, and uses any one or a combination of the defect type, the defect coordinates and a historical information of the to-be-detected leather to calculate an estimated price of leather.

2. The leather defect detection system as claimed in claim 1, wherein the embedded computing device is an artificial intelligence computing device of a Jetson nano kit.

3. The leather defect detection system as claimed in claim 1, wherein the model training computing device further comprises a data augmentation module to perform data augmentation (DA) image processing on the historical leather images in order to obtain a plurality of augmented images to be used as another training sample for the defect identification model after being processed by the pre-processing module.

4. The leather defect detection system as claimed in claim 1, wherein the model training module further adjusts or retrains the defect identification model based on a calculation result of a defect judgment formula, and the defect judgment formula comprises the following relational expressions:
accuracy=(TP+TN)/(TP+FP+FN+TN);
recall=TP/(TP+FN); and
precision=TP/(TP+FP);
wherein TP represents an actual defect, and the defect identification model accurately judges as a defect;
TN represents an actual non-defect, and the defect identification model accurately judges as a non-defect;
FP represents an actual defect, and the defect identification model misjudges as a non-defect; and
FN represents an actual non-defect, and the defect identification model misjudges as a defect.

5. The leather defect detection system as claimed in claim 1, wherein the conveying mechanism comprises:
a frame disposed on the worktable;
a slide rail disposed apart from the worktable on the frame;
a moving seat movably disposed on the slide rail and used to carry the image capture module; and
a driving unit connected with the moving seat to drive the moving seat to move relative to the slide rail so that the image capture module is capable of capturing the whole to-be-detected leather during a moving process.

6. The leather defect detection system as claimed in claim 5, wherein the driving unit has a control module, a motor and a transmission component, the control module is an artificial intelligence calculation device of an Arduino Nano kit for controlling operation and stop of the motor, and the transmission component converts and transmits rotational motions of the motor to the moving seat, so that the moving seat is capable of reciprocating in a direction in which the slide rail extends.

7. The leather defect detection system as claimed in claim 1, wherein the historical information comprises leather types, origins, leather-cutting parts and leather sizes.

8. The leather defect detection system as claimed in claim 7, wherein the leather-cutting parts include shoulders, abdomen, square leather and buttocks.

9. The leather defect detection system as claimed in claim 1, wherein the defect type is classified into dot, fine dot, line, strip, irregularity, pattern or hole according to shape and form.

10. The leather defect detection system as claimed in claim 1, further comprising a display module electrically connected to the image capture module, the model training computing device and the embedded computing device respectively.
